(19) United States
(12) Patent Application Publication
(10) Pub. No.: US 2024/0232719 A1
(43) Pub. Date: Jul. 11, 2024

(54) SEMI-FEDERATED LEARNING METHOD BASED ON NEXT-GENERATION MULTIPLE ACCESS TECHNOLOGY

(71) Applicant: Beijing University of Posts and Telecommunications, Beijing (CN)

(72) Inventors: Hui TIAN, Beijing (CN); Wanli NI, Beijing (CN); Ping ZHANG, Beijing (CN); Keyan LIU, Beijing (CN); Shaoshuai FAN, Beijing (CN); Gaofeng NIE, Beijing (CN)

(73) Assignee: Beijing University of Posts and Telecommunications, Beijing (CN)

(21) Appl. No.: 18/515,317

(22) Filed: Nov. 21, 2023

(30) Foreign Application Priority Data
Jan. 5, 2023 (CN) 202310012159.4

(51) Int. Cl. G06N 20/00

(52) U.S. Cl. CPC G06N 20/00

(57) ABSTRACT

A semi-federated learning (semiFL) method based on a next-generation multiple access (NGMA) technology is provided. Centralized learning (CL) and FL are integrated such that devices with weak computing capabilities can also participate in training of a global model. A simultaneously transmitting and reflecting reconfigurable intelligent surface (STAR-RIS) is deployed to dynamically change a channel environment such that a system can meet different task requirements of heterogeneous users. Communication-centric CL users and computing-centric FL users can transmit data in parallel on a same time-frequency resource. This avoids a waste of data resources, enriches data obtaining of a base station (BS), and improves accuracy of the global model. The semiFL method also integrates a strategy for jointly optimizing user power allocation and a configuration of the STAR-RIS to reduce total uplink transmit power consumption of the system and prolong a life cycle of an intelligent Internet of Things (IoT) network.

### CROSS REFERENCE TO THE RELATED APPLICATIONS

This application is based upon and claims priority to Chinese Patent Application No. 202310012159.4, filed on Jan. 5, 2023, the entire contents of which are incorporated herein by reference.

### TECHNICAL FIELD

The present disclosure relates to the technical field of federated learning (FL), and in particular, to a semi-federated learning (semiFL) method based on a next-generation multiple access (NGMA) technology.

### BACKGROUND

With rapid development and integration of machine learning (ML) and wireless communication, massive distributed devices can generate a large amount of real-time information and multimodal data. In a large-scale wireless Internet of Things (IoT) scenario, scarce spectrum resources lead to a communication bottleneck. In addition, the massive distributed devices have different computing capabilities. These factors cause intelligent IoT that relies upon traditional ML technology to face severe challenges.

Although FL can significantly reduce communication overheads and training time of traditional centralized learning (CL), the distributed characteristic of FL compromises training accuracy of a model. In addition, an important feature of FL different from CL is that powerful computing resources of a base station (BS) are not easily used for model training in FL, user data is locally stored, and all nodes perform model training on local devices. However, an actual large-scale wireless IoT scenario cannot meet this requirement because devices have heterogeneous computing capabilities and it is difficult for devices with weak computing capabilities to cooperate with devices with strong computing capabilities to train a shared model. The foregoing limitations of IoT make existing ML paradigms (such as CL and FL) inefficient when the paradigms are directly combined with traditional communication technologies. Therefore, it is highly desirable to develop a new learning-oriented network technology for high-efficient model training in wireless IoT.

In addition, it is necessary to realize that communication and computing of devices in a system require considerable energy. IoT devices with limited battery capacity are difficult to support normal operation of a distributed system for a long time. Furthermore, some devices may be deployed in inaccessible or dangerous locations, making periodic charging of the batteries very difficult. Therefore, it is very important to design a high-efficient power control strategy to prolong a life cycle of a wireless IoT network.

### SUMMARY

To resolve a problem that intelligent performance of a network edge is reduced due to heterogeneous computing capabilities of devices and limited resources in an existing intelligent IoT scenario, the present disclosure provides a semiFL method based on an NGMA technology. CL and FL are integrated such that devices with weak computing capabilities can also participate in training of a global model. In addition, a simultaneously transmitting and reflecting reconfigurable intelligent surface (STAR-RIS) is deployed to dynamically change a channel environment such that a system can meet different task requirements of heterogeneous users. Communication-centric CL users and computing-centric FL users can transmit data in parallel on a same time-frequency resource. This avoids a waste of data resources, enriches data obtaining of a BS, and improves accuracy of the global model. The method provided in the present disclosure also integrates a strategy for jointly optimizing user power allocation and a configuration of the STAR-RIS to reduce total uplink transmit power consumption of the system and prolong a life cycle of an intelligent IoT network.

To achieve the foregoing objective, the present disclosure provides the following technical solutions:

The present disclosure provides a semiFL method based on an NGMA technology, including the following steps:
S1: reporting, by users, state information to a BS, where the state information includes instantaneous channel state information (CSI) and available central processing unit (CPU) frequency state information;
S2: after receiving the reported state information, classifying, by the BS, the users into communication-centric CL users and computing-centric FL users based on computing capabilities of local devices of the users, and broadcasting a classification result to all users after classification;
S3: training, by each FL user, a local model through a local data set based on a global model W obtained in a previous round, and computing a local gradient gₖ; and preparing, by each CL user, a local data set Dₙ to be uploaded to the BS;
S4: encoding the local data set of each CL user into a communication symbol {sₙ}, processing the gradient of the local model trained by each FL user into a computation symbol {sₖ}, and sending, by all users, the information bearing symbols of the users to the BS by using the NGMA technology in combination with a STAR-RIS;
S5: receiving, by the BS, a superimposed signal from the two types of users, decoding the local data sets from the CL users to perform centralized training and obtain an average gradient, aggregating the gradients of the local models from the FL users, and aggregating a global model by using the obtained gradients:
S6: after each round of communication is completed, broadcasting, by the BS, the latest global model w∈ [symbol] ^{Q} to all FL users for gradient computation in a next round; and
S7: repeating the foregoing steps until convergence or a maximum quantity of rounds of communication is reached.

Further, the NGMA technology in S4 provides services for all users in a same frequency band in a non-orthogonal manner such that all users are capable of communicating in parallel on a same time-frequency resource.

Further, the STAR-RIS deployed in S4 modifies an amplitude and a phase of an incident signal to reshape a wireless transmission environment and adjust channel gains of different users.

Further, S5 specifically includes:
S51: detecting, by the BS, communication output {sₙ} of each CL user through successive interference cancellation (SIC), decoding the communication output to generate training samples {Dₙ} for CL, and training the model through a gradient descent method to obtain the average gradient g̅∈ [symbol] ^{Q} of the CL users as follows:

$$CL : \overline{g} = \frac{1}{N} {\sum }_{n ∈ N} {g}_{n} = \frac{1}{N} {\sum }_{n ∈ N} ▽ {F}_{n} ( w ; {D}_{n} )$$

where N is a quantity of the CL users, gₙ=∇Fₙ(w;Dₙ)∈ [symbol] ^{Q} represents a gradient of the n^{th} CL user computed by the BS,

$${F}_{n} ( w ; {D}_{n} ) = \frac{1}{\vert {D}_{n} \vert} {\sum }_{i = 1}^{\vert {D}_{n} \vert} f ( w ; {D}_{n}^{( i )} )$$

is an objective function used to train a model parameter w∈ [symbol] ^{Q}, and ƒ(w;Dₙ⁽ⁱ⁾) is a loss function of the model with respect to the i^{th} sample Dₙ⁽ⁱ⁾ of the n^{th} CL user;
S52: assuming that all symbols from the CL users are successfully decoded in S51, subtracting, by the BS, signals of the CL users from the received superimposed signal to obtain a residual signal

$$\hat{y} = {\sum }_{k ∈ K} {\overline{h}}_{k} \sqrt{{p}_{k}} {s}_{k} + {z}_{0}$$

that contains signals of the FL users, performing averaging on the residual signal that contains the signals of the FL users, restoring the local gradients {gₖ} of the FL users from the computation symbols {sₖ}, and finally obtaining an estimated average gradient of the FL users as follows:

$$FL : \hat{g} = \frac{\hat{y}}{K} = \frac{1}{K} ( {\sum }_{k ∈ K} {\overline{h}}_{k} \sqrt{{p}_{k}} {g}_{k} + {z}_{0} )$$

where K is a quantity of the FL users, z₀˜ N (0,σ²I)∈ [symbol] ^{Q} is a noise vector at the BS, and σ² is noise power;
S53: after obtaining the gradients {g̅,ĝ}, updating, by the BS, a global gradient as follows:

$$SemiFL : \tilde{g} = \frac{N}{N + K} \overline{g} + \frac{K}{N + K} \hat{g}$$

updating the global model by using w:=w−λ\tilde{g}, where λ>0 is a learning rate.

Further, before each round of communication, user transmit power allocation and a configuration of the STAR-RIS are jointly optimized with an objective of minimizing total transmit power consumption of the round, and an optimization problem and constraints are constructed as follows:

$$s . t .$$

$${min}_{\{ {p}_{u} \} , \{ {Θ}_{u} \}} {\sum }_{u = 1}^{N + K} {p}_{u}$$

$${\vert {\overline{h}}_{1} \vert}^{2} \geq … {\vert {\overline{h}}_{N} \vert}^{2} \geq {\vert {\overline{h}}_{k} \vert}^{2} , ∀ k ∈ K ,$$

$${R}_{n} ( \{ {p}_{u} \} , \{ {Θ}_{u} \} ) \geq {R}_{min} , ∀ n ∈ N ,$$

$$MSE ( \{ {p}_{k} \} , \{ {Θ}_{k} \} ) \leq {E}_{0} ,$$

$${p}_{u} \geq 0 , {Θ}_{u} ∈ Q , ∀ u ∈ U ,$$

where U=N∪K is a set of all users, N≙32 {1, 2, . . . , N} is a set of the CL users. K≙{N+1, N+2, . . . , N+K} is a set of the FL users, pᵤ is transmit power of the u^{th} user, Θᵤ is a coefficient matrix of the STAR-RIS of the u^{th} user, h̅ᵤ is a joint channel of the BS, the STAR-RIS and the user, Q={βₘ^{R}, βₘ^{T}, θₘ^{R}, θₘ^{T}|βₘ^{R}, βₘ^{T}∈{0, 1}; θₘ^{R}, θₘ^{T}∈[0,2π]; βₘ^{R}+βₘ^{T}=1} is a feasible set of refraction and reflection coefficients of the STAR-RIS, βₘ^{χ}∈{0,1} and θₘ^{χ}∈[0,2π] are respectively an amplitude and a phase shift of an m^{th} element in χ∈{R, T} mode, Rₘᵢₙ is a minimum data transmission rate for meeting a quality of service (Qos) requirement of the CL users, E₀ is a maximum computation distortion that the FL users can tolerate, Rₙ ({pᵤ}, {Θᵤ}) is a data transmission rate of the n^{th} CL user, and MSE({pₖ}, {Θₖ}) is a computation distortion of the k^{th} FL user.

Further, the optimization problem is decoupled into two subproblems. Alternating optimization is performed on the transmit power {pₙ} of the user and the configuration {Θᵤ} of the STAR-RIS of the user.

Further, during the alternating optimization, when {Θᵤ} is fixed, for the {pᵤ} subproblem, the constraints are rewritten by using an uplink communication rate expression

$${R}_{n} = B {log}_{2} ( 1 + \frac{{\vert {\overline{h}}_{n} \vert}^{2} {p}_{n}}{{\sum }_{u = n + 1}^{N + K} {\vert {\overline{h}}_{u} \vert}^{2} {p}_{u} + {σ}^{2}} ) ,$$

$$∀ n ∈ N$$

of the CL user and a computation distortion expression

$$MSE \hat{=} E [ {\vert \hat{s} - \frac{1}{K} {\sum }_{k ∈ K} {s}_{k} \vert}^{2} ] = \frac{1}{{K}^{2}} ( {\sum }_{k ∈ K} {\vert {\overline{h}}_{k} \sqrt{{p}_{k}} - 1 \vert}^{2} + {σ}^{2} )$$

of the FL user, to equivalently express the user power allocation subproblem.

For a transformed expression, power allocation {pₖ} of the FL users is fixed, and the following closed-form expression of optimal power allocation {p*ₙ} of the CL users is derived through mathematical induction:

$${p}_{n}^{*} = {ζ ( ζ + 1 )}^{N - n} ( {\sum }_{k = N + 1}^{N + K} {\vert {\overline{h}}_{k} \vert}^{2} {p}_{k}^{*} + {σ}^{2} ) {\vert {\overline{h}}_{n} \vert}^{- 2}$$

Power allocation {pₙ} of the CL users is fixed, \hat{p}ₖ=\sqrt{pₖ}, the optimization problem is reorganized, and the following closed-form expression of optimal power allocation {p*ₖ} of the FL users is obtained through a Lagrange duality method:

$${p}_{k}^{*} = {τ}_{2}^{* 2} {\vert {\overline{h}}_{k} \vert}^{2} {( 1 + {τ}_{1}^{*} ζ {\vert {\overline{h}}_{k} \vert}^{2} + {τ}_{2}^{*} {\vert {\overline{h}}_{k} \vert}^{2} )}^{- 2}$$

where τ*₁ is an optimal dual variable related to the QoS constraint, and τ*₂ is an optimal dual variable related to the MSE constraint.

Further, during the alternating optimization, when {pₙ} is fixed, the {Θₙ} subproblem is a feasibility check problem and is expressed as follows:

$$find \{ {Θ}_{u} \}$$

$$s . t . {\vert {\overline{h}}_{1} \vert}^{2} \geq … {\vert {\overline{h}}_{N} \vert}^{2} \geq {\vert {\overline{h}}_{k} \vert}^{2} ,$$

$$∀ k ∈ K ,$$

$${R}_{n} ( \{ {p}_{u} \} , \{ {Θ}_{u} \} ) \geq {R}_{min} ,$$

$$∀ n ∈ N ,$$

$$MSE ( \{ {p}_{k} \} , \{ {Θ}_{k} \} ) \leq {E}_{0} ,$$

$${Θ}_{u} ∈ Q ,$$

$$∀ u ∈ U ,$$

$${R}_{u} = diag \{ {\overline{r}}^{H} \} {r}_{u} ,$$

$${\overline{R}}_{u} = [ \begin{matrix}{R}_{u} {R}_{u}^{H} & {R}_{u} {h}_{u}^{H} \\ {h}_{u} {R}_{u}^{H} & 0\end{matrix} ] ,$$

$${\overline{q}}_{u} = [ \begin{matrix}{q}_{u} \\ 1\end{matrix} ] ,$$

$$and$$

$${Q}_{u} = {\overline{q}}_{u} {\overline{q}}_{u}^{H}$$

are introduced. A joint uplink channel coefficient is rewritten. The subproblem is further expressed. Qᵤ±0, Diag(Qₙ)=βᵤ, a non-convex rank-one constraint rank(Qᵤ)=1 exists, and a transformed expression also has a binary variable.

∥Qᵤ∥₀−∥Qᵤ∥₂=0, ∀u∈U and βₘ^{χ}−(βₘ^{χ})²=0, ∀_{χ}∈{R, T}, ∀m∈M are introduced to transform the non-convex rank-one constraint and the binary variable into penalty terms in an objective function. Because the penalty terms are non-convex, convex upper bounds of the penalty terms are obtained through first-order Taylor expansion in an [symbol] ^{th} iteration as follows:

$${‖ {Q}_{u} ‖}_{*} - {‖ {Q}_{u} ‖}_{2} \leq {‖ {Q}_{u} ‖}_{*} - \{ {‖ {Q}_{u} [ ℓ ] ‖}_{2} + tr [ {\overline{q}}_{max} [ ℓ ] {( {\overline{q}}_{max} [ ℓ ] )}^{H} ( {Q}_{u} - {Q}_{u} [ ℓ ] ) ] \} ,$$

$${β}_{m}^{χ} - {( {β}_{m}^{χ} )}^{2} \leq {β}_{m}^{χ} - [ {( {β}_{m}^{χ} [ ℓ ] )}^{2} + 2 {β}_{m}^{χ} [ ℓ ] ( {β}_{m}^{χ} - {β}_{m}^{χ} [ ℓ ] ) ]$$

The convex upper bounds are introduced to the objective function as penalty functions to obtain a convex semidefinite programming (SDP) problem.

Further, solving the convex SDP problem includes: continuously updating penalty factors η₁ and η₂ of the penalty terms, and solving the SDP problem through an iterative method until the penalty terms satisfy a predefined maximum violation or a predefined maximum quantity of outer iterations is reached.

Further, performing alternating optimization on the user power allocation subproblem and the STAR-RIS configuration subproblem specifically includes: initializing {pᵤ[0]}, {Qᵤ[0]}, {βᵤ[0]}, and preset accuracy Ò₃; and setting a current iteration index [symbol] ₃=0, given {Qᵤ[ [symbol] ₃]} and {βᵤ[ [symbol] ₃]}, computing {pᵤ[ [symbol] ₃+1]} by using a closed-form expression of optimal user power allocation, given {pᵤ[ [symbol] ₃+1]}, updating {Qᵤ[ [symbol] ₃+1]} and {Bᵤ[ [symbol] +1]} through a penalty-based successive convex approximation (SCA) method, updating [symbol] ₃= [symbol] ₃+1, and repeating the foregoing process until a value of an objective function decreases to the preset accuracy or a preset maximum quantity L₃ of iterations is reached.

Compared with the prior art, the present disclosure has the following beneficial effects:

The present disclosure provides the semiFL method based on an NGMA technology. CL and FL are integrated such that devices with weak computing capabilities can also participate in training of the global model. During uplink transmission, channel conditions of users are flexibly adjusted through the STAR-RIS to dynamically change a channel environment such that a system can meet different task requirements of heterogeneous users. Communication-centric CL users with weak local computing capabilities and computing-centric FL users with strong local computing capabilities can transmit data in parallel on a same time-frequency resource. This avoids a waste of data resources, enriches data obtaining of the BS, and improves accuracy of the global model.

In a large-scale wireless IoT scenario, an underlying device may face a dilemma of limited battery capacity and inconvenient periodic charging, which seriously affects a life cycle of an entire system. To resolve this problem, the present disclosure constructs a mixed integer non-linear programming problem for jointly optimizing power allocation and the configuration of the STAR-RIS with an objective of minimizing user transmit power consumption. The proposed non-convex optimization problem can be decoupled into two subproblems. For the user power allocation subproblem, the closed-form expressions of the optimal power allocation can be derived through mathematical induction and the Lagrange duality method. For the STAR-RIS configuration subproblem, the original feasibility check problem can be transformed into the convex SDP problem through a penalty function method and the SCA method, and the SDP problem is solved through CVX. In summary, the method provided in the present disclosure integrates a strategy for jointly optimizing the user power allocation and the configuration of the STAR-RIS to reduce total uplink transmit power consumption of the system and prolong a life cycle of an intelligent IoT network.

### BRIEF DESCRIPTION OF THE DRAWINGS

To describe the technical solutions in embodiments of the present application or in the prior art more clearly, the following briefly describes the accompanying drawings required for describing the embodiments. Apparently, the accompanying drawings in the following description show merely some embodiments of the present disclosure, and persons of ordinary skill in the art may still derive other accompanying drawings from these accompanying drawings.

FIG. 1 is a flowchart of a semiFL method based on an NGMA technology according to an embodiment of the present disclosure;

FIG. 2 is an architectural diagram of a semiFL method based on an NGMA technology according to an embodiment of the present disclosure;

FIG. 3 is an application structural diagram of a semiFL method based on an NGMA technology according to an embodiment of the present disclosure; and

FIG. 4 is a principle diagram of a STAR-RIS-assisted NGMA technology according to an embodiment of the present disclosure.

### DETAILED DESCRIPTION OF THE EMBODIMENTS

The present disclosure provides a semiFL method based on an NGMA technology. CL and FL are integrated such that devices with weak computing capabilities in a large-scale wireless IoT scenario can also participate in training of a global model. During uplink transmission, a channel environment of a user is flexibly adjusted through a STAR-RIS such that CL users with weak computing capabilities and FL users with strong computing capabilities can communicate in parallel on a shared time-frequency resource. Then, the present disclosure studies how to minimize total user transmit power consumption, constructs a mixed integer non-linear programming problem for jointly optimizing user power allocation and a configuration of the STAR-RIS, and obtains an optimal suboptimal solution through alternating optimization. Specifically, for the user power allocation subproblem, closed-form expressions of optimal power are obtained through mathematical induction and a Lagrange duality method. For the STAR-RIS configuration subproblem, a feasibility check problem is transformed into a convex SDP problem through a penalty function method and an SCA method.

To better understand the technical solutions, the following describes in detail a method in the present disclosure with reference to the accompanying drawings. Apparently, the described embodiments are merely some rather than all of the embodiments of the present disclosure. All other embodiments obtained by those of ordinary skill in the art based on the embodiments of the present disclosure without creative efforts shall fall within the protection scope of the present disclosure.

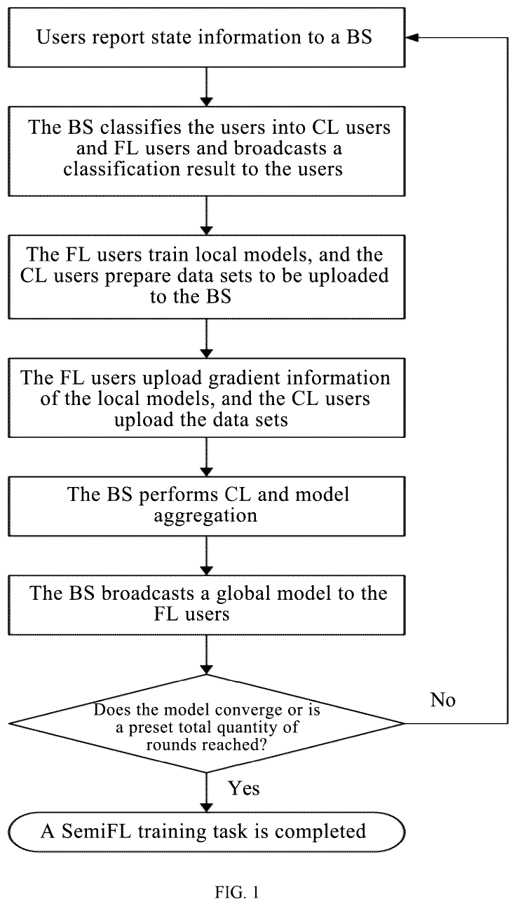

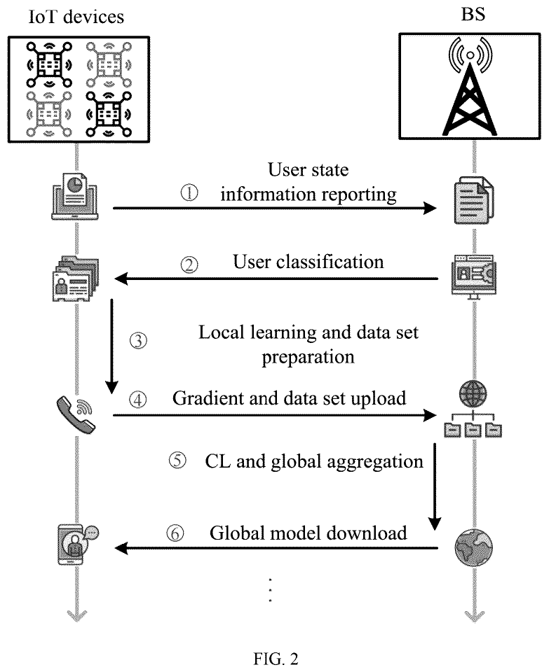

Referring to FIG. 1 and FIG. 2, in a semiFL method based on an NGMA technology provided in the present disclosure, all users participate in training of a global model and can transmit data in parallel on a shared time-frequency resource. The method includes the following steps:
S1: Before each round of communication starts, state information such as instantaneous CSI and available CPU frequency state information is estimated and reported to a BS by all local users.
S2: After the reported state information is received, the users are classified by the BS into communication-centric CL users and computing-centric FL users based on computing capabilities of local devices of the users, and a classification result is broadcast to all users after classification.

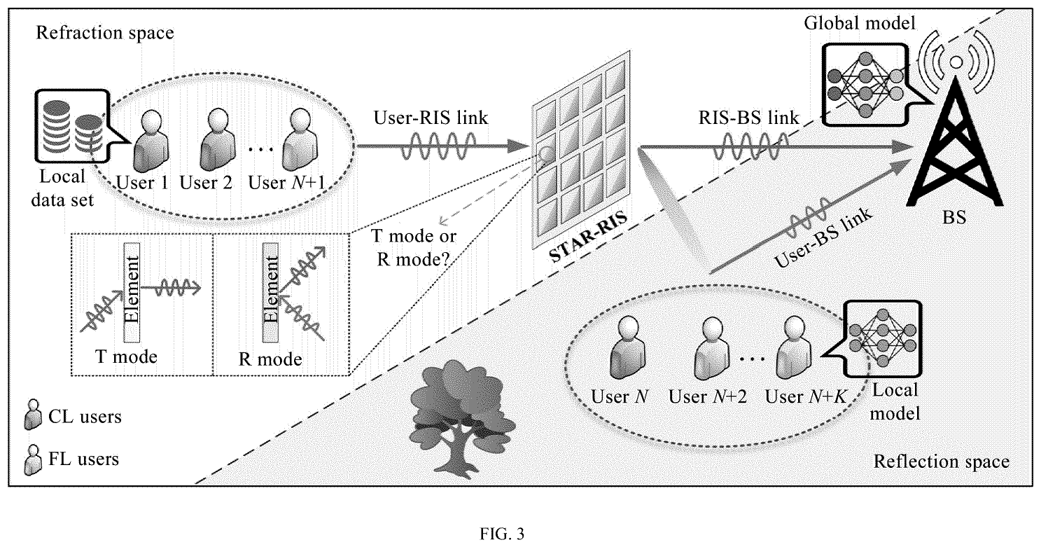

A STAR-RIS-assisted wireless network that supports collaborative learning for heterogeneous users is considered, as shown in FIG. 3. A heterogeneous user set U=N∪K is divided into communication-centric CL users N=≙{1, 2, . . . , N} with weak computing capabilities and computing-centric FL users K ≙{N+1, N+2, . . . , N+K} with strong computing capabilities based on different computing capabilities of the local devices of the users. There are M passive reflective/refractive elements in a STAR-RIS. Each element relays (refracts or reflects) an incident signal to a desired direction. To avoid energy leakage and facilitate synchronous communication of all users, the STAR-RIS uses a mode switching protocol to select at least one of the elements to work in total refraction mode (namely, T mode) and the other elements to work in total reflection mode (namely, R mode). q_{χ}=\sqrt{[β₁^{χ}} e^{jθ}^{₁}^{χ}, \sqrt{β₂^{χ}} e^{jθ}^{₂}^{χ}, . . . , \sqrt{β_{M}^{χ}} e^{jθ}^{_{M}}^{χ}]^{H} represents a reflection (χ=R) and refraction (χ=T) vector. βₘ^{χ}∈{0,1} and θₘ^{χ}∈[0,2π] respectively represent an amplitude and a phase shift of the m^{th} element in χ∈{R, T} mode. Because each element can work in only one mode in a specific timeslot, a constraint on mode switching is βₘ^{R}+βₘ^{T}=1, ∀m∈M≙{1, 2, . . . , M}.

A channel gain of a wireless link can be obtained by multiplying a path loss by small-scale fading. Specifically, a link distance from the STAR-RIS to the BS and the user is denoted as Λᵤ, ∀u∈Ū≙{0}∪U. u=0) represents the BS. u∈U represents the user. Large-scale fading is denoted as Lᵤ=ζ₀(Λᵤ)^{-α}, ∀u∈Ū≙{0}∪U. ζ₀ is a path loss at a reference distance of 1 m. α≥2 is a path loss index. For small-scale fading, the present disclosure assumes that a channel between the user and the BS is subject to Rayleigh fading due to blocking and extensive scattering. Because the STAR-RIS is deployed at height, it can be assumed that all RIS-related links are subject to Ricean fading. Therefore, the present disclosure can represent a channel coefficient of all RIS-related links as follows:

$${r}_{u} = \sqrt{\frac{{ς}_{0}}{{Λ}_{u}^{α}}} ( \sqrt{\frac{κ}{κ + 1}} {r}_{u}^{LoS} + \sqrt{\frac{1}{κ + 1}} {r}_{u}^{NLoS} ) ,$$

$$∀ u ∈ \overline{U}$$

κ is a Ricean factor. rᵤ^{LoS}∈ [symbol] ^{M} is a deterministic line-of-sight channel component. rᵤ^{NLoS}∈ [symbol] ^{M} is a Rayleigh fading channel component. The STAR-RIS divides effective coverage of the BS into refraction space and reflection space. In a system in which the STAR-RIS is deployed, a joint channel coefficient of an up link from the u^{th} user to the BS is as follows:

$${\overline{h}}_{u} = \text{?} + {r}_{0}^{H} {Θ}_{u} {r}_{u} ,$$

$$∀ u ∈ U$$

$$\text{?} \text{indicates text missing or illegible when filed}$$

hᵤ∈ [symbol] represents a direct link from the u^{th} user to the BS. r₀^{H}Θᵤrᵤ represents a double fading reflection/refraction link provided by the STAR-RIS. Specifically, if the u^{th} user is located in the reflection space, Θᵤ=diag(q_{R}). If the u^{th} user is located in the refraction space, Θᵤ=diag(q_{T}). The present disclosure assumes that instantaneous CSI of all channels is available at the BS.
S3: A local gradient gₖ is computed by each FL user based on a model W obtained in a previous round, and a local data set Dₙ to be uploaded to the BS is prepared by each CL user.
S4: The local data set of each CL user is encoded into a communication symbol {sₙ}, the gradient of the local model trained by each FL user is processed into a computation symbol {sₖ}, and the information bearing symbols of all users are sent to the BS by using an NGMA technology.

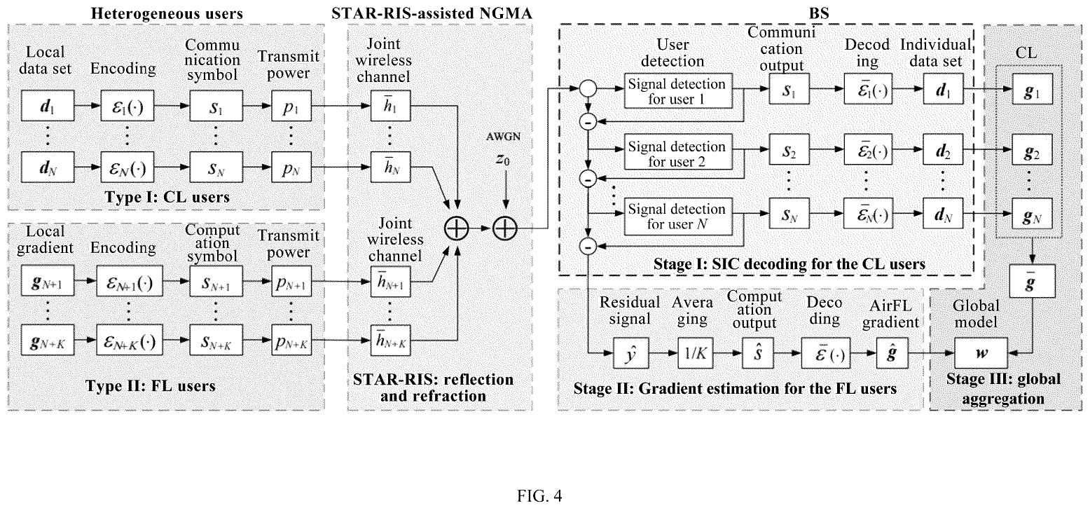

Referring to FIG. 4, the present disclosure designs an NGMA technology integrating a non-orthogonal multiple access (NOMA) technology and an AirComp technology by utilizing a superimposition characteristic of signals in a wireless channel. Wireless access services are provided for CL and FL users through a STAR-RIS-assisted multiple access channel such that uplink communication of an original data set of the CL user and over-the-air computation of a model parameter (such as gradient information) of the FL user are multiplexed in a same frequency band.

In each round of communication, the CL user maps the local data set {dₙ} to the communication symbol {sₙ} and the FL user maps and the gradient {gₖ} to the computation symbol {sₖ} first. The NGMA technology provides services for all users in a same frequency band in a non-orthogonal manner such that the users can concurrently perform uplink communication. The communication symbol {sₙ} is transmitted through a power domain NOMA technology. The computation symbol {sₖ} is transmitted through the AirComp technology. Therefore, a superimposed signal received by the BS is as follows:

$$y = {\underbrace{{\sum }_{n = 1}^{N} {\overline{h}}_{n} \sqrt{{p}_{n}} {s}_{n}}}_{CL users} + {\underbrace{{\sum }_{k = N + 1}^{N + K} {\overline{h}}_{k} \sqrt{{p}_{k}} {s}_{k}}}_{FL users} + {\underbrace{{z}_{0}}}_{Noise}$$

pₙ (pₖ) is transmit power of the n^{th} (k^{th}) user. z₀˜CN (0,σ²) is additive white Gaussian noise (AWGN) at the BS. The present disclosure assumes that all symbols {sᵤ}={sₙ}∪{sₖ} are statistically independent and have zero mean and normalized variance, that is, E[sᵤ²]=1, ∀u∈U and E[sᵤ^{H}s_{ν}]=0, ∀u≠#ν∈U.

With the help of the STAR-RIS, it can be ensured that parallel communication between the two groups of users is smooth even if some direct links between the BS and the users are blocked. The CL users and the FL users have different communication objectives and performance indicators. For example, the communication-centric CL users expect that the local data sets sent to the BS can be perfectly decoded by the BS with an objective of maximizing a data transmission rate. The computing-centric FL users expect that local model parameters sent to the BS can be carefully aggregated by the BS with an objective of minimizing a computation distortion MSE. Considering the plurality of objectives involved in NGMA, the present disclosure expects to improve throughput of the CL users by suppressing interference, while completing weighting computation of the model parameters of the FL users by utilizing the superimposition characteristic of channels. Therefore, there is a need to design a collaborative transmission mechanism with an efficient interference management capability in such a joint communication and learning framework.

Heterogeneous users are classified into strong users and weak users based on different path losses. The BS separates the superimposed signal through SIC to perfectly decode a signal from the strong users. The strong signal is modulated and subtracted from the received superimposed signal V to obtain a signal from the weak users. This leaves the weak signal for collaborative over-the-air computation. To implement the foregoing process, the present disclosure needs to reshape a wireless transmission environment by modifying an amplitude and a phase of an incident signal through the STAR-RIS such that channel gains of the two groups of users are adjusted in the following order:

$${\underbrace{{\vert {\overline{h}}_{1} \vert}^{2} \geq {\vert {\overline{h}}_{2} \vert}^{2} \geq … \geq {\vert {\overline{h}}_{N} \vert}^{2}}}_{Strong users} \geq {\underbrace{{\vert {\overline{h}}_{k} \vert}^{2} , ∀ k ∈ K}}_{Weak users}$$

Specifically, a channel coefficient is adjusted through the STAR-RIS to arrange all CL users as strong users for communication message decoding and all FL users as weak users for model aggregation. Based on the superimposed signal and a decoding order, an uplink communication rate of the n^{th} CL user is as follows:

$${R}_{n} = B {log}_{2} ( 1 + \frac{{\vert {\overline{h}}_{n} \vert}^{2} {p}_{n}}{{\sum }_{u = n + 1}^{N + K} {\vert {\overline{h}}_{u} \vert}^{2} {p}_{u} + {σ}^{2}} ) ,$$

$$∀ n ∈ N$$

B is available bandwidth of the system.

The communication symbols {sₙ} sent by the CL users may be decoded and modulated by the BS, and subtracted from the superimposed signal y received by the BS to obtain a residual signal

$$\hat{y} = {\sum }_{k ∈ K} {\overline{h}}_{k} \sqrt{{p}_{k}} {s}_{k} + {z}_{0}$$

that contains gradient information of the models of the FL users. For aggregation of the FL models, linear computation output estimated by the BS is as follows:

$$\hat{s} = \frac{\hat{y}}{K} = \frac{1}{K} ( {\sum }_{k ∈ K} {\overline{h}}_{k} \sqrt{{p}_{k}} {s}_{k} + {z}_{0} )$$

A computation distortion may be quantified by a mean square error (MSE) as follows:

$$MSE \hat{=} E [ {\vert \hat{s} - \frac{1}{K} {\sum }_{k ∈ K} {s}_{k} \vert}^{2} ] = \frac{1}{{K}^{2}} ( {\sum }_{k ∈ K} {\vert {\overline{h}}_{k} \sqrt{{p}_{k}} - 1 \vert}^{2} + {σ}^{2} )$$

S5: The superimposed signal from the two groups of users is received by the BS, the local data sets from the CL users are decoded to perform centralized training and obtain an average gradient, the gradients of the local models from the FL users are aggregated, and a global model is aggregated by using the obtained gradients.

Specifically, referring to FIG. 4, the BS first detects communication output {sₙ} of each CL user through SIC, decodes the communication output to generate training samples {Dₙ} for CL, and trains the model through a gradient descent method to obtain the average gradient g̅∈ [symbol] ^{Q} of the CL users as follows:

$$CL : \overline{g} = \frac{1}{N} {\sum }_{n ∈ N} {g}_{n} = \frac{1}{N} {\sum }_{n ∈ N} ∇ {F}_{n} ( w ; {D}_{n} )$$

where N is a quantity of the CL users, gₙ=∇Fₙ(w;Dₙ)∈ [symbol] ^{Q} represents a gradient of the n^{th} CL user computed by the BS,

$${F}_{n} ( w ; {D}_{n} ) = \frac{1}{\vert {D}_{n} \vert} {\sum }_{i = 1}^{\vert {D}_{n} \vert} f ( w ; {D}_{n}^{( i )} )$$

is an objective function used to train a model parameter w∈ [symbol] ^{Q}, and ƒ(w;Dₙ⁽ⁱ⁾) is a loss function of the model with respect to the i^{th} sample Dₙ⁽ⁱ⁾ of the n^{th} CL user.

Then, the BS subtracts the decoded information symbols of the CL users from the received superimposed signal to obtain the residual signal

$$\hat{y} = {\sum }_{k ∈ K} {\overline{h}}_{k} \sqrt{{p}_{k}} {s}_{k} + {z}_{0}$$

that contains model information of the FL users, performs averaging on the residual signal, restores the local gradients {gₖ} of the FL users from the computation symbols {sₖ}, and finally obtains an estimated average gradient of the FL users as follows:

$$FL : \hat{g} = \frac{\hat{y}}{K} = \frac{1}{K} ( {\sum }_{k ∈ K} {\overline{h}}_{k} \sqrt{{p}_{k}} {g}_{k} + {z}_{0} )$$

where K is a quantity of the FL users, z₀˜N (0,σ²I)∈ [symbol] ^{Q} is a noise vector at the BS, and σ² is noise power.

Finally, after obtaining the gradients (g̅,ĝ), the BS updates a global gradient as follows:

$$SemiFL : \tilde{g} = \frac{N}{N + K} \overline{g} + \frac{K}{N + K} \hat{g}$$

The global model is updated by using w:=w−λ\tilde{g}, where λ>0 is a learning rate.
S6: After each round of communication is completed, the latest global model w∈ [symbol] ^{Q} is broadcast by the BS to all FL users for gradient computation in a next round.
S7: The foregoing steps are repeated until convergence or a maximum quantity of rounds of communication is reached.

The semiFL method based on an NGMA technology provided in the present disclosure considers reducing total uplink transmit power consumption while meeting requirements for computation distortion tolerance of the FL users and data transmission rates of the CL users. Specifically, before each round of communication, an optimization problem and constraints are constructed with an objective of minimizing total transmit power consumption of the round. User transmit power allocation and a configuration of the STAR-RIS are jointly optimized through alternating optimization.

The objective of the present disclosure is to minimize the total transmit power consumption of each round of communication by jointly optimizing uplink power allocation for all users and the configuration of the STAR-RIS. Considering a QoS requirement of the CL users and the computation distortion tolerance of the FL users, the considered optimization problem can be expressed as follows:

$${min}_{\{ {p}_{u} \} , \{ {Θ}_{u} \}} {\sum }_{u = 1}^{N + K} {p}_{u}$$

$$s . t . {\vert {\overline{h}}_{1} \vert}^{2} \geq ⋯ {\vert {\overline{h}}_{N} \vert}^{2} \geq {\vert {\overline{h}}_{k} \vert}^{2} , ∀ k ∈ K ,$$

$${R}_{n} ( \{ {p}_{u} \} , \{ {Θ}_{u} \} ) \geq {R}_{min} , ∀ n ∈ N ,$$

$$MSE ( \{ {p}_{k} \} , \{ {Θ}_{k} \} ) \leq {E}_{0} ,$$

$${p}_{u} \geq 0 , {Θ}_{u} ∈ Q , ∀ u ∈ U ,$$

Q={βₘ^{R}, βₘ^{T}, θₘ^{R}, θₘ^{T}|βₘ^{R}, βₘ^{T}∈{0, 1}; θₘ^{R}, θₘ^{T}∈[0,2π]; βₘ^{R}+βₘ^{T}=1} is a feasible set of refraction and reflection coefficients of the STAR-RIS. Rₘᵢₙ is a minimum data transmission rate for meeting the requirement of the CL users. The constraint |h̅₁|²≥ . . . |h̅_{N}|²≥|h̅ₖ|², ∀k∈K represents a decoding order that ensures successful separation of the communication symbols and the computation symbols. The constraint Rₙ({pᵤ}, {Θᵤ})≥Rₘᵢₙ, ∀n∈N is the QoS requirement of the CL users. The constraint MSE({pₖ}, {Θₖ})≤ E₀ ensures that the computation distortion of the FL users does not exceed E₀<1/K.

Due to non-convexity of the constraints, directly solving the constructed optimization problem faces the following difficulties: First, optimization of the configuration of the STAR-RIS is more complex than that of a traditional RIS with only reflection coefficients. Second, existence of the discrete variable {βₘ^{(χ)}} and other continuous variables makes the optimization problem a mixed integer programming problem. It is difficult to find optimal solutions of the highly coupled variables {pᵤ} and {Θᵤ} in polynomial time complexity. To effectively solve the proposed problem, the present disclosure decouples the problem into two subproblems: a power allocation subproblem and a STAR-RIS configuration subproblem. Alternating optimization is performed on the two subproblems.

Given the configuration of the STAR-RIS, the related constraints are rewritten by using the expression of the uplink communication rate of the CL user and the expression of the computation distortion MSE of the FL user, to equivalently express the power allocation subproblem in the optimization problem as follows:

$${min}_{\{ {p}_{u} \geq 0 \}} {\sum }_{u = 1}^{N + K} {p}_{u}$$

$$s . t . {\vert {\overline{h}}_{n} \vert}^{2} {p}_{n} \geq ζ ( {\sum }_{u = n + 1}^{N + K} {\vert {\overline{h}}_{u} \vert}^{2} {p}_{u} + {σ}^{2} ) , ∀ n ∈ N ,$$

$${\sum }_{k = N + 1}^{N + K} {\vert {\overline{h}}_{k} \sqrt{{p}_{k}} - 1 \vert}^{2} + {σ}^{2} \leq {E}_{0} {K}^{2} ,$$

ζ=2^{R}^{ₘᵢₙ}^{/B}−1 is a constant. In the present disclosure, optimal solutions of the problem are obtained by using an analytical structure and a Lagrange duality method. Finally obtained closed-form expressions of optimal transmit power {p*ₙ} of the CL user and optimal transmit power {p*ₖ} of the FL user are as follows:

$${p}_{n}^{*} = {ζ ( ζ + 1 )}^{N - n} ( {\sum }_{k = N + 1}^{N + K} {\vert {\overline{h}}_{k} \vert}^{2} {p}_{k}^{*} + {σ}^{2} ) {\vert {\overline{h}}_{n} \vert}^{- 2} ,$$

$${p}_{k}^{*} = {τ}_{2}^{* 2} {\vert {\overline{h}}_{k} \vert}^{2} {( 1 + {τ}_{1}^{*} ζ {\vert {\overline{h}}_{k} \vert}^{2} + {τ}_{2}^{*} {\vert {\overline{h}}_{k} \vert}^{2} )}^{- 2} .$$

Σ*₁ is an optimal dual variable related to the QoS constraint. Σ*₂ is an optimal dual variable related to the MSE constraint.

A specific proof process for the optimal transmit power {p*ₙ} and {p*ₖ} is as follows:

The solution of the transmit power {pᵤ} is composed of {pₙ} of the CL user and {pₖ} of the FL user.

First, given {pₖ}, the power allocation subproblem degenerates to:

$${min}_{\{ {p}_{u} \geq 0 \}} {\sum }_{u = 1}^{N + K} {p}_{n}$$

$$s . t . {\vert {\overline{h}}_{n} \vert}^{2} {p}_{n} \geq ζ ( {\sum }_{u = n + 1}^{N + K} {\vert {\overline{h}}_{u} \vert}^{2} {p}_{u} + {σ}^{2} ) , ∀ n ∈ N ,$$

Based on an analytical structure of the problem, it can be proved through reduction to absurdity that

$${\vert {\overline{h}}_{n} \vert}^{2} {p}_{n} \geq ζ ( {\sum }_{u = n + 1}^{N + K} {\vert {\overline{h}}_{u} \vert}^{2} {p}_{u} + {σ}^{2} ) , ∀ n ∈ N$$

is a valid constraint for the optimal solution that meets a minimum QoS requirement. Therefore, given {pₖ}, optimal transmit power of the N^{th} CL user can be written as follows:

$${p}_{N}^{*} = \frac{ζ}{{\vert {\overline{h}}_{N} \vert}^{2}} ( {\sum }_{k = N + 1}^{N + K} {\vert {\overline{h}}_{k} \vert}^{2} {p}_{k} + {σ}^{2} )$$

Optimal transmit power of the (N−1)^{th} CL user can be written as follows:

$$\begin{matrix}{p}_{N - 1}^{*} & = \frac{ζ}{{\vert {\overline{h}}_{N - 1} \vert}^{2}} ( {\vert {\overline{h}}_{N} \vert}^{2} {p}_{N}^{*} + {\sum }_{k = N + 1}^{N + K} {\vert {\overline{h}}_{k} \vert}^{2} {p}_{k} + {σ}^{2} ) \\ & {=}^{( e )} \frac{ζ ( ζ + 1 )}{{\vert {\overline{h}}_{N - 1} \vert}^{2}} ( {\sum }_{k = N + 1}^{N + K} {\vert {\overline{h}}_{k} \vert}^{2} {p}_{k} + {σ}^{2} )\end{matrix}$$

(e) can be derived by substituting the expression of p*_{N} into the expression of p*_{N-1}, with some simple algebraic operations. Similarly, optimal transmit power of the (N−2)^{th} CL user is as follows:

$${p}_{N - 2}^{*} = \frac{{ζ ( ζ + 1 )}^{2}}{{\vert {\overline{h}}_{N - 2} \vert}^{2}} ( {\sum }_{k = N + 1}^{N + K} {\vert {\overline{h}}_{k} \vert}^{2} {p}_{k} + {σ}^{2} )$$

In summary, a closed-form solution of {p*ₙ} can be obtained through induction.

Then, given {pₙ}, \hat{p}ₖ=\sqrt{pₖ} and the power allocation subproblem can be reformulated as follows:

$${min}_{\{ {\hat{p}}_{k} \geq 0 \}} {\sum }_{k = N + 1}^{N + K} {\hat{p}}_{k}^{2}$$

$$s . t . ζ {\sum }_{k = N + 1}^{N + K} {\vert {\overline{h}}_{k} \vert}^{2} {\hat{p}}_{k}^{2} \leq {I}_{min} ,$$

$${\sum }_{k = N + 1}^{N + K} {\vert \overline{{h}_{k}} {\hat{p}}_{κ} - 1 \vert}^{2} + {σ}^{2} \leq {E}_{0} {K}^{2} ,$$

$$where {I}_{min} = {min}_{n ∈ N} \{ {\vert {\overline{h}}_{n} \vert}^{2} {p}_{n} - ζ {\sum }_{u = n + 1}^{N + K} {\vert {\overline{h}}_{u} \vert}^{2} {p}_{u} - ζ {σ}^{2} \} .$$

Σ₁≥0 and Σ₂≥0 represent Lagrange multipliers, and a Lagrange function of the transformed subproblem is as follows:

$$L ( \{ {\hat{p}}_{k} \} , {τ}_{1} , {τ}_{2} ) = {\sum }_{k = N + 1}^{N + K} {\hat{p}}_{k}^{2} + {τ}_{1} ( ζ {\sum }_{k = N + 1}^{N + K} {\vert {\overline{h}}_{k} \vert}^{2} {\hat{p}}_{k}^{2} - {I}_{min} ) + {τ}_{2} ( {\sum }_{k = N + 1}^{N + K} {\vert {\overline{h}}_{k} {\hat{p}}_{k} - 1 \vert}^{2} + {σ}^{2} - {E}_{0} {K}^{2} )$$

A dual function of the Lagrange function is as follows:

$$D ( {τ}_{1} , {τ}_{2} ) = {min}_{\{ {\hat{p}}_{k} \geq 0 \}} L ( \{ {\hat{p}}_{k} \} , {τ}_{1} , {τ}_{2} )$$

Therefore, a dual problem of the transformed subproblem is as follows:

$${max}_{{τ}_{1} , {τ}_{2} \geq 0} D ( {τ}_{1} , {τ}_{2} )$$

Given the dual variables τ₁ and τ₂, an optimal solution

$${\hat{p}}_{k}^{*} = \frac{{τ}_{2} \vert {\overline{h}}_{k} \vert}{1 + {τ}_{1} ζ {\vert {\overline{h}}_{k} \vert}^{2} + {τ}_{2} {\vert {\overline{h}}_{k} \vert}^{2}}$$

of the dual function can be obtained by finding an extreme point that satisfies

$$\frac{\partial L}{\partial {\hat{p}}_{k}^{*}} = 2 {\hat{p}}_{k}^{*} + 2 {τ}_{1} ζ {\vert {\overline{h}}_{k} \vert}^{2} {\hat{p}}_{k}^{*} + 2 {τ}_{2} \vert {\overline{h}}_{k} {\hat{p}}_{k} - 1 \vert \vert {\overline{h}}_{k} \vert = 0.$$

The dual function D(τ₁, τ₂) is obtained by substituting the optimal solution into the expression of the dual function. For the proposed dual problem, optimal Lagrange multipliers τ*₁ and τ*₂ are found through a subgradient descent method, that is:

$${τ}_{1} [ ℓ + 1 ] = {[ {τ}_{1} [ ℓ ] + {\tilde{μ}}_{1} ( ζ {\sum }_{k ∈ K} {\vert {\overline{h}}_{k} \vert}^{2} {\hat{p}}_{k}^{* 2} - {I}_{min} ) ]}^{+}$$

$${τ}_{2} [ ℓ + 1 ] = {[ {τ}_{2} [ ℓ ] + {\tilde{μ}}_{2} ( {\sum }_{k ∈ K} {\vert {\overline{h}}_{k} {\hat{p}}_{k}^{*} - 1 \vert}^{2} + {σ}^{2} - {E}_{0} {K}^{2} ) ]}^{+}$$

[symbol] is an iteration index. \tilde{μ}₁, \tilde{μ}₂>0 is a step, which is a constant. The optimal transmit power of the FL user can be obtained by replacing {τ₁, τ₂} in the expression of \hat{p}*ₖ with the obtained optimal dual variables {τ*₁, τ*₂} and using p*ₖ=\hat{p}*₂² to restore {p*ₖ}.

The proof is completed.

Given the user transmit power, because an objective function in the optimization problem is independent of {Θᵤ}, the STAR-RIS configuration subproblem is a feasibility check problem, which can be equivalently expressed as follows:

$$find \{ {Θ}_{u} \}$$

$$s . t . {\vert {\overline{h}}_{1} \vert}^{2} \geq ⋯ {\vert {\overline{h}}_{N} \vert}^{2} \geq {\vert {\overline{h}}_{k} \vert}^{2} , ∀ k ∈ K ,$$

$${R}_{n} ( \{ {p}_{u} \} , \{ {Θ}_{u} \} ) \geq {R}_{min} , ∀ n ∈ N ,$$

$$MSE ( \{ {p}_{k} \} , \{ {Θ}_{k} \} ) \leq {E}_{0} ,$$

$${Θ}_{u} ∈ Q , ∀ u ∈ U ,$$

The present disclosure further defines Rᵤ=diag{r̅^{H}}rᵤ. In this case, r̅^{H}Θᵤrᵤ=qᵤ^{H}Rᵤ. If the u^{th} user is located in the reflection space, qᵤ=q_{R}. If the u^{th} user is located in the refraction space. qᵤ=q_{T}. Correspondingly, in the present disclosure, the following can be obtained:

$$\begin{matrix}{\vert {\overline{h}}_{u} \vert}^{2} & = {\vert {h}_{u} + {\overline{r}}^{H} {Θ}_{u} {r}_{u} \vert}^{2} = \vert {h}_{u} + {q}_{u}^{H} {R}_{u} {\vert}^{2} \\ & = {q}_{u}^{H} {R}_{u} {R}_{u}^{H} {q}_{u} + {q}_{u}^{H} {R}_{u} {h}_{u}^{H} + {h}_{u} {R}_{u}^{H} {q}_{u} + {\vert {h}_{u} \vert}^{2} \\ & = {\overline{q}}_{u}^{H} {\overline{R}}_{u} {\overline{q}}_{u} + {\vert {h}_{u} \vert}^{2}\end{matrix}$$

where

$${\overline{R}}_{u} = [ \begin{matrix}{R}_{u} {R}_{u}^{H} & {R}_{u} {h}_{u}^{H} \\ {h}_{u} {R}_{u}^{H} & 0\end{matrix} ] , {\overline{q}}_{u} = [ \begin{matrix}{q}_{u} \\ 1\end{matrix} ] .$$

It can be found that q̅ᵤ^{H}R̅ᵤq̅ᵤ=tr(R̅ᵤq̅ᵤq̅ᵤ^{H}). Qᵤ=q̅ᵤq̅ᵤ^{H} is defined, and Qᵤ±0, rank(Qᵤ)=1, and Diag(Qᵤ)=βᵤ need to be satisfied. The vector Diag(Qᵤ) represents an element extracted from a main diagonal of a matrix Qᵤ. If the u^{th} user is located in the reflection space, βᵤ=β_{R}=[β₁^{R}, β₂^{R}, . . . , β_{M}^{R}]*. Otherwise. βᵤ=β_{T}=[β₁^{T}, β₂^{T}, . . . , β_{M}^{T}]*. Next, a joint uplink channel coefficient may be further organized as follows:

$${\vert {\overline{h}}_{u} \vert}^{2} = tr ( {\overline{R}}_{u} {\overline{q}}_{u} {\overline{q}}_{u}^{H} ) + {\vert {h}_{u} \vert}^{2} = tr ( {\overline{R}}_{u} {Q}_{u} ) + {\vert {h}_{u} \vert}^{2}$$

Similarly,

$${{R}^{◦}}_{k} = {R}_{k} \sqrt{{p}_{k}} , {\hat{h}}_{k} = {h}_{k} \sqrt{{p}_{k}} - 1 , and {\hat{R}}_{k} = [ \begin{matrix}{{R}^{◦}}_{k} {{R}^{◦}}_{k}^{H} & {{R}^{◦}}_{k} {\hat{h}}_{k}^{H} \\ {\hat{h}}_{k} {{R}^{◦}}_{k}^{H} & 0\end{matrix} ]$$

are defined.

In this case, in the present disclosure, the following can be obtained:

$${\vert {\overline{h}}_{k} \sqrt{{p}_{k}} - 1 \vert}^{2} = tr ( {\hat{R}}_{k} {Q}_{k} ) + {\vert {\hat{h}}_{k} \vert}^{2}$$

Based on the foregoing transformation, the first three non-convex constraints in the STAR-RIS configuration subproblem can be re-expressed as follows:

$$tr ( {\overline{R}}_{1} {Q}_{1} ) + {\vert {h}_{1} \vert}^{2} \geq … \geq tr ( {\overline{R}}_{N} {Q}_{N} ) + {\vert {h}_{N} \vert}^{2}$$

$$\geq tr ( {\overline{R}}_{k} {Q}_{k} ) + {\vert {h}_{k} \vert}^{2} , ∀ k ∈ K ,$$

$$[ tr ( {\overline{R}}_{n} {Q}_{n} ) + {\vert {h}_{n} \vert}^{2} ] {p}_{n}$$

$$\geq ζ {σ}^{2} + ζ {\sum }_{u = n + 1}^{N + K} [ tr ( {\overline{R}}_{u} {Q}_{u} ) + {\vert {h}_{u} \vert}^{2} ] {p}_{u} , ∀ n ∈ N ,$$

$${\sum }_{k ∈ K} [ tr ( {\hat{R}}_{k} {Q}_{k} ) + {\vert {\hat{h}}_{k} \vert}^{2} ] + {σ}^{2} \leq {E}_{0} {K}^{2}$$

Based on the foregoing approximations, the STAR-RIS configuration subproblem can be approximated as follows:

$$find \{ {Q}_{u} \} , \{ {β}_{u} \}$$

$$s . t . {Q}_{u} \pm 0 , ∀ u ∈ U ,$$

$$rank ( {Q}_{u} ) = 1 , ∀ u ∈ U ,$$

$$Diag ( {Q}_{u} ) = {β}_{u} , ∀ ι ι ∈ U ,$$

$${β}_{m}^{R} + {β}_{m}^{T} = 1 , ∀ m ∈ M ,$$

$${β}_{m}^{R} , {β}_{m}^{T} ∈ \{ 0 , 1 \} , ∀ m ∈ M$$

$$tr ( {\overline{R}}_{1} {Q}_{1} ) + {\vert {h}_{1} \vert}^{2} \geq … \geq tr ( {\overline{R}}_{N} {Q}_{N} ) + {\vert {h}_{N} \vert}^{2} \geq tr ( {\overline{R}}_{k} {Q}_{k} ) + {\vert {h}_{k} \vert}^{2} , ∀ k ∈ K ,$$

$$[ tr ( {\overline{R}}_{n} {Q}_{n} ) + {\vert {h}_{n} \vert}^{2} ] {p}_{n} \geq {ζσ}^{2} + ζ {\sum }_{u = n + 1}^{N + K} [ tr ( {\overline{R}}_{u} {Q}_{u} ) + {\vert {h}_{u} \vert}^{2} ] {p}_{u} , ∀ n ∈ N ,$$

$${\sum }_{k ∈ K} [ tr ( {\hat{R}}_{k} {Q}_{k} ) + {\vert {\hat{h}}_{k} \vert}^{2} ] + {σ}^{2} \leq {E}_{0} {K}^{2}$$

In the present disclosure, the non-convex rank-one constraint and the binary constraint in the foregoing problem can be equivalently transformed into the following form:

$$rank ( {Q}_{u} ) = 1 ⇔ {‖ {Q}_{u} ‖}_{*} - {‖ {Q}_{u} ‖}_{2} = 0 , ∀ u ∈ U ,$$

$${β}_{m}^{χ} ∈ \{ 0 , 1 \} ⇔ {β}_{m}^{χ} - {( {β}_{m}^{χ} )}^{2} = 0 , ∀ χ ∈ \{ R , T \} , ∀ m ∈ M$$

∥⋅∥_{*} represents a kernel norm. ∥⋅∥₂ represents a spectral norm.

Then, the present disclosure adds the foregoing two equations to the objective function of the transformed subproblem as penalty terms, to obtain the following problem:

$${min}_{\{ {Q}_{u} \} , \{ {β}_{u} \}} {η}_{1} {\sum }_{u} ( {‖ {Q}_{u} ‖}_{*} - {‖ {Q}_{u} ‖}_{2} ) + {η}_{2} {\sum }_{m} {\sum }_{χ} ( {β}_{m}^{χ} - {( {β}_{m}^{χ} )}^{2} )$$

$$s . t . {Q}_{u} \pm 0 , ∀ u ∈ U ,$$

$$Diag ( {Q}_{u} ) = {β}_{u} , ∀ ι ι ∈ U ,$$

$${β}_{m}^{R} + {β}_{m}^{T} = 1 , ∀ m ∈ M ,$$

$$tr ( {\overline{R}}_{1} {Q}_{1} ) + {\vert {h}_{1} \vert}^{2} \geq … \geq tr ( {\overline{R}}_{N} {Q}_{N} ) + {\vert {h}_{N} \vert}^{2} \geq tr ( {\overline{R}}_{k} {Q}_{k} ) + {\vert {h}_{k} \vert}^{2} , ∀ k ∈ K ,$$

$$[ tr ( {\overline{R}}_{n} {Q}_{n} ) + {\vert {h}_{n} \vert}^{2} ] {p}_{n} \geq {ζσ}^{2} + ζ {\sum }_{u = n + 1}^{N + K} [ tr ( {\overline{R}}_{u} {Q}_{u} ) + {\vert {h}_{u} \vert}^{2} ] {p}_{u} , ∀ n ∈ N ,$$

$${\sum }_{k ∈ K} [ tr ( {\hat{R}}_{k} {Q}_{k} ) + {\vert {\hat{h}}_{k} \vert}^{2} ] + {σ}^{2} \leq {E}_{0} {K}^{2}$$

η₁ and η₂ are two non-negative penalty factors that penalize the objective function if a rank of {Qᵤ} is not 1 or {βₘ^{χ}} is not binary. However, these penalty terms make the objective function of the foregoing problem non-convex. In the present disclosure, a suboptimal solution is obtained through continuous iterations by using an SCA method. Specifically, in the present disclosure, ∥Qᵤ∥₂ and (βₘ^{χ})² are linearized by using fixed points Qᵤ[ [symbol] ] and βₘ^{χ}[ [symbol] ] through first-order Taylor expansion in an [symbol] ^{th} iteration, that is:

$${‖ {Q}_{u} ‖}_{*} - {‖ {Q}_{u} ‖}_{2} \leq {‖ {Q}_{u} ‖}_{*} - \{ {‖ {Q}_{u} [ ℓ ] ‖}_{2} + tr [ {\overline{q}}_{max} [ ℓ ] {( {\overline{q}}_{max} [ ℓ ] )}^{H} ( {Q}_{u} - {Q}_{u} [ ℓ ] ) ] \} ,$$

$${β}_{m}^{χ} - {( {β}_{m}^{χ} )}^{2} \leq {β}_{m}^{χ} - [ {( {β}_{m}^{χ} [ ℓ ] )}^{2} + 2 {β}_{m}^{χ} [ ℓ ] ( {β}_{m}^{χ} - {β}_{m}^{χ} [ ℓ ] ) ]$$

Then, the non-convex penalty terms in the [symbol] ^{th} iteration are replaced by solved convex upper bounds. A transformed problem is a convex SDP problem, which can be effectively solved through CVX. A penalty-based SCA algorithm proposed to solve the STAR-RIS configuration subproblem is composed of two loops: an inner loop used to iteratively solve an approximate SDP problem of the configuration subproblem and an outer loop used to continuously update the penalty factors and determine whether an iteration termination condition is met. A constraint violation is defined as follows:

$$\overline{o} = max \{ {‖ {Q}_{u} ‖}_{*} - {‖ {Q}_{u} ‖}_{2} , {β}_{m}^{χ} - {( {β}_{m}^{χ} )}^{2} \}$$

The algorithm is described in detail below.

Specifically, {Qᵤ[0]}, {βᵤ[0]}, the penalty factors η₁ and η₂, corresponding scale factors ñ₁ and ñ₂, and preset accuracy ò₁ and ò₂ are initialized first. An outer iteration index [symbol] ₁=0 is set. The constraint violation ō[ [symbol] ₁] is computed. An inner iteration index [symbol] ₂=0 is set. An objective function value Eₜₒₜ[ [symbol] ₂] of the approximate SDP problem of the STAR-RIS configuration subproblem is computed. [symbol] ₂= [symbol] ₂+1 is updated. The approximate SDP problem is solved to update Qᵤ[ [symbol] ₂] and βᵤ[ [symbol] ₂]. The objective function value Eₜₒₜ[ [symbol] ₂] is updated. The foregoing process is repeated until

$$\frac{\vert {E}_{t o t} [ {ℓ}_{2} ] - {E}_{tot} [ {ℓ}_{2} - 1 ] \vert}{{E}_{tot} [ {ℓ}_{{2}^{-}} 1 ]} \leq {ò}_{2}$$

or a quantity of inner iterations [symbol] ₂≥L₂. [symbol] ₁= [symbol] ₁+1, Qᵤ[ [symbol] ₁]=Qᵤ[ [symbol] ₂], βᵤ[ [symbol] ₁]=βᵤ[ [symbol] ₂], the constraint violation ō[ [symbol] ₁], η₁=ñ₁η₁, and η₂=ñ₂η₂ are updated. The foregoing process is repeated until [symbol] ₁]≤₁ or [symbol] ₁≥L₁.

The present disclosure proposes an alternating optimization algorithm to jointly optimize the user power allocation and the configuration of the STAR-RIS, to minimize the total uplink transmit power consumption.

Specifically, {pᵤ[0]}, {Qᵤ[0]}, {βᵤ[0]}, and preset accuracy ò₃ are initialized. A current iteration index [symbol] ₃=0 is set. Given {Qᵤ[ [symbol] ₃]} and {βᵤ[ [symbol] ₃]}, {pᵤ[ [symbol] ₃+1]} is computed by using a closed-form expression of optimal user power allocation. Given {pᵤ[ [symbol] ₃+1]}, {Qᵤ[ [symbol] ₃+1]} and {βᵤ[ [symbol] ₃+1]} are updated through the penalty-based SCA algorithm. [symbol] ₃= [symbol] ₃+1 is updated. The foregoing process is repeated until a value of the objective function decreases to the preset accuracy or a preset maximum quantity L₃ of iterations is reached.

Because the total transmit power decreases as a quantity of iterations increases in the alternating optimization algorithm, and there is a lower bound constraint, the proposed alternating optimization algorithm can ensure convergence. In each iteration, computational complexity of the algorithm mainly depends on the step of solving the approximate SDP problem, with complexity of O(LₒLᵢ(M²+M)³). L₀=min {L₁, log(1/ò₁)} and Lᵢ=min{L₂, log(1/ò₂)} respectively represent quantities of outer and inner iterations required for the convergence of the penalty-based SCA algorithm.

Simulation results show that the method provided in the present disclosure can effectively reduce communication overheads and transmission delay in comparison with CL and can improve learning accuracy in comparison with FL.

The foregoing embodiments are used only to describe the technical solutions of the present disclosure, and are not intended to limit same. Although the present disclosure is described in detail with reference to the foregoing embodiments, those of ordinary skill in the art should understand that they can still modify the technical solutions described in the foregoing embodiments, or make equivalent substitutions to some technical features therein. These modifications or substitutions do not make the essence of the corresponding technical solutions depart from the spirit and scope of the technical solutions of the embodiments of the present disclosure.

What is claimed is:

1. A semi-federated learning (semiFL) method based on a next-generation multiple access (NGMA) technology, comprising the following steps:
S1: reporting, by users, state information to a base station (BS), wherein the state information comprises instantaneous channel state information (CSI) and available central processing unit (CPU) frequency state information;
S2: after receiving the state information, classifying, by the BS, the users into communication-centric centralized learning (CL) users and computing-centric FL users based on computing capabilities of local devices of the users, and broadcasting a classification result to all users after classification;
S3: training, by each FL user, a local model through a local data set based on a global model w obtained in a previous round, and computing a local gradient gₖ; and preparing, by each CL user, a local data set Dₙ to be uploaded to the BS;
S4: encoding the local data set of each CL user into a communication symbol {sₙ}, processing the gradient of the local model trained by each FL user into a computation symbol {sₖ}, and sending, by all users, the information bearing symbols of the users to the BS by using the NGMA technology in combination with a simultaneously transmitting and reflecting reconfigurable intelligent surface (STAR-RIS);
S5: receiving, by the BS, a superimposed signal from the CL users and the FL users, decoding the local data sets from the CL users to perform centralized training and obtain an average gradient, aggregating the gradients of the local models from the FL users, and aggregating a global model by using the obtained gradients;
S6: after each round of communication is completed, broadcasting, by the BS, the latest global model w∈ [symbol] ^{Q} to all FL users for gradient computation in a next round; and
S7: repeating the foregoing steps until convergence or a maximum quantity of rounds of communication is reached.

2. The semiFL method based on the NGMA technology according to claim 1, wherein the NGMA technology in S4 provides services for all users in a same frequency band in a non-orthogonal manner such that all users are allowed to communicate in parallel on a same time-frequency resource.

3. The semiFL method based on the NGMA technology according to claim 1, wherein the STAR-RIS deployed in S4 modifies an amplitude and a phase of an incident signal to reshape a wireless transmission environment and adjust channel gains of different users.

4. The semiFL method based on the NGMA technology according to claim 1, wherein S5 comprises:
S51: detecting, by the BS, communication output {sₙ} of each CL user through successive interference cancellation (SIC), decoding the communication output to generate training samples {Dₙ} for CL, and training a CL model through a gradient descent method to obtain the average gradient g̅∈ [symbol] ^{Q} of the CL users as follows:
$$CL : \overline{g} = \frac{1}{N} {\sum }_{n ∈ N} {g}_{n} = \frac{1}{N} {\sum }_{n ∈ N} ∇ {F}_{n} ( w ; {D}_{n} )$$
wherein N is a quantity of the CL users, gₙ=∇Fₙ(w; Dₙ)∈ [symbol] ^{Q} represents a gradient of an n^{th} CL user computed by the BS,
$${F}_{n} ( w ; {D}_{n} ) = \frac{1}{\vert {D}_{n} \vert} {\sum }_{i = 1}^{\vert {D}_{n} \vert} f ( w ; {D}_{n}^{( i )} )$$
is an objective function used to train a model parameter w∈ [symbol] ^{Q}, and ƒ(w;Dₙ⁽ⁱ⁾) is a loss function of the CL model with respect to an i^{th} sample Dₙ⁽ⁱ⁾ of the n^{th} CL user;
S52: assuming that all symbols from the CL users are successfully decoded in S51, subtracting, by the BS, signals of the CL users from the received superimposed signal to obtain a residual signal
$$\hat{y} = {\sum }_{k ∈ K} {\overline{h}}_{k} \sqrt{{p}_{k}} {s}_{k} + {z}_{0}$$
that contains signals of the FL users, performing averaging on the residual signal that contains the signals of the FL users, restoring the local gradients {gₖ} of the FL users from the computation symbols {sₖ}, and finally obtaining an estimated average gradient of the FL users as follows:
$$FL : \hat{g} = \frac{\hat{y}}{K} = \frac{1}{K} ( {\sum }_{k ∈ K} {\overline{h}}_{k} \sqrt{{p}_{k}} {g}_{k} + {z}_{0} )$$
wherein K is a quantity of the FL users, z₀˜N (0, σ²I)∈ [symbol] ^{Q} is a noise vector at the BS, and σ² is noise power; and
S53: after obtaining the gradients {g̅, ĝ}, updating, by the BS, a global gradient as follows:
$$SemiFL : \tilde{g} = \frac{N}{1 y + K} \overline{g} + \frac{K}{N + K} \hat{g} ,$$
and updating the global model by using w:=w−λ\tilde{g}, wherein λ>0 is a learning rate.

5. The semiFL method based on the NGMA technology according to claim 1, wherein before each round of communication, user transmit power allocation and a configuration of the STAR-RIS are jointly optimized with an objective of minimizing total transmit power consumption of the round, and an optimization problem and constraints are constructed as follows:
$${min}_{\{ {p}_{n} \} , \{ {Θ}_{u} \}} {\sum }_{u = 1}^{N + K} {p}_{u}$$
$$s . t . {\vert {\overline{h}}_{1} \vert}^{2} \geq … {\vert {\overline{h}}_{N} \vert}^{2} \geq {\vert {\overline{h}}_{k} \vert}^{2} , ∀ k ∈ K ,$$
$${R}_{n} ( \{ {p}_{u} \} , \{ {Θ}_{u} \} ) \geq {R}_{min} , ∀ n ∈ N ,$$
$$MSE ( \{ {p}_{k} \} , \{ {Θ}_{k} \} ) \leq {E}_{0} ,$$
$${p}_{u} \geq 0 , {Θ}_{u} ∈ Q , ∀ u ∈ U ,$$
wherein U=N∪K is a set of all users, N≙{1, 2, . . . , N} is a set of the CL users, K≙{N+1, N+2, . . . , N+K} is a set of the FL users, pᵤ is transmit power of the u^{th} user, Θᵤ is a coefficient matrix of the STAR-RIS of the u^{th} user, h̅ᵤ is a joint channel of the BS, the STAR-RIS and the user, Q={βₘ^{R}, βₘ^{T}, θₘ^{R}, θₘ^{T}|βₘ^{R}, βₘ^{T}∈{0, 1}; θₘ^{R}, θₘ^{T}∈[0, 2π]; βₘ^{R}+βₘ^{T}=1} is a feasible set of refraction and reflection coefficients of the STAR-RIS, βₘ^{χ}∈{0,1} and θₘ^{χ}∈[0,2π] are respectively an amplitude and a phase shift of an m^{th} element in χ∈{R, T} mode, Rₘᵢₙ is a minimum data transmission rate for meeting a quality of service (QOS) requirement of the CL users, E₀ is a maximum computation distortion that the FL users are allowed to tolerate, Rₙ({pᵤ}, {Θᵤ}) is a data transmission rate of the n^{th} CL user, and MSE({pₖ}, {θₖ}) is a computation distortion of a k^{th} FL user.

6. The semiFL method based on the NGMA technology according to claim 5, wherein the optimization problem is decoupled into two subproblems, and alternating optimization is performed on the transmit power {pᵤ} of the user and the configuration {Θᵤ} of the STAR-RIS of the user.

7. The semiFL method based on the NGMA technology according to claim 6, wherein during the alternating optimization, when {Θᵤ} is fixed, for the {pᵤ} subproblem, the constraints are rewritten by an uplink communication using rate expression
$${R}_{n} = B {log}_{2} ( 1 + \frac{{\vert {\overline{h}}_{n} \vert}^{2} {p}_{n}}{{\sum }_{u = N + 1}^{N + K} {\vert {\overline{h}}_{u} \vert}^{2} {p}_{u} + {σ}^{2}} ) , ∀ n ∈ N$$
of the CL user and a computation distortion expression
$$MSE {=}^{△} E [ {\vert \hat{s} \frac{1}{K} {\sum }_{k ∈ K} {s}_{k} \vert}^{2} ] = \frac{1}{{K}^{2}} ( {\sum }_{k ∈ K} {\vert {\overline{h}}_{k} \sqrt{{p}_{k}} - 1 \vert}^{2} + {σ}^{2} )$$
of the FL user, to equivalently express the user power allocation subproblem;
for a transformed expression, power allocation {pₖ} of the FL users is fixed, and the following closed-form expression of optimal power allocation {p*ₙ} of the CL users is derived through mathematical induction:
$${p}_{n}^{*} = {ζ ( ζ + 1 )}^{N - n} ( {\sum }_{k = N + 1}^{N + K} {\vert {\overline{h}}_{k} \vert}^{2} {p}_{k}^{*} + {σ}^{2} ) {\vert {\overline{h}}_{n} \vert}^{- 2}$$
power allocation {pₙ} of the CL users is fixed, \hat{p}ₖ=\sqrt{pₖ}, the optimization problem is reorganized, and the following closed-form expression of optimal power allocation {p*ₖ} of the FL users is obtained through a Lagrange duality method:
$${p}_{k}^{*} = {τ}_{2}^{* 2} {\vert {\overline{h}}_{k} \vert}^{2} {( 1 + {τ}_{1}^{*} ζ {\vert {\overline{h}}_{k} \vert}^{2} + {τ}_{2}^{*} {\vert {\overline{h}}_{k} \vert}^{2} )}^{- 2}$$
wherein τ*₁ is an optimal dual variable related to a QoS constraint, and τ*₂ is an optimal dual variable related to a mean square error (MSE) constraint.

8. The semiFL method based on the NGMA technology according to claim 6, wherein during the alternating optimization, when {pᵤ} is fixed, the {Θᵤ} subproblem is a feasibility check problem and is expressed as follows:
$$find \{ {Θ}_{u} \}$$
$$s . t . {\vert {\overline{h}}_{1} \vert}^{2} \geq … {\vert {\overline{h}}_{N} \vert}^{2} \geq {\vert {\overline{h}}_{k} \vert}^{2} , ∀ k ∈ K ,$$
$${R}_{n} ( \{ {p}_{u} \} , \{ {Θ}_{u} \} ) \geq {R}_{min} , ∀ n ∈ N ,$$
$$MSE ( \{ {p}_{k} \} , \{ {Θ}_{k} \} ) \leq {E}_{0} ,$$
$${Θ}_{u} ∈ Q , ∀ u ∈ U ,$$
$${R}_{u} = diag \{ {\overline{r}}^{H} \} {r}_{u} , {\overline{R}}_{u} = [ \begin{matrix}{R}_{u} {R}_{u}^{H} & {R}_{u} {h}_{u}^{H} \\ {h}_{u} {R}_{u}^{H} & 0\end{matrix} ] , {\overline{q}}_{u} = [ \begin{matrix}{q}_{u} \\ 1\end{matrix} ] , and {Q}_{u} = {\overline{q}}_{u} {\overline{q}}_{u}^{H}$$
are introduced, a joint uplink channel coefficient is rewritten, the subproblem is further expressed, Qᵤ±0, Diag(Qᵤ)=βᵤ, a non-convex rank-one constraint rank(Qᵤ)=1 exists, and a transformed expression also has a binary variable;
∥Qᵤ∥₀−∥Qᵤ∥₂=0, ∀u∈U and βₘ^{χ}−(βₘ^{χ})²=0, ∀_{χ}∈{R, T}, ∀m∈M are introduced to transform the non-convex rank-one constraint and the binary variable into penalty terms in an objective function, and because the penalty terms are non-convex, convex upper bounds of the penalty terms are obtained through first-order Taylor expansion in an [symbol] ^{th} iteration as follows:
$${‖ {Q}_{u} ‖}_{*} - {‖ {Q}_{u} ‖}_{2} \leq {‖ {Q}_{u} ‖}_{*} - \{ {‖ {Q}_{u} [ ℓ ] ‖}_{2} + tr [ {\overline{q}}_{max} [ ℓ ] {( {\overline{q}}_{max} [ ℓ ] )}^{H} ( {Q}_{u} - {Q}_{u} [ ℓ ] ) ] \} ,$$
$${β}_{m}^{χ} - {( {β}_{m}^{χ} )}^{2} \leq {β}_{m}^{χ} - [ {( {β}_{m}^{χ} [ ℓ ] )}^{2} + 2 {β}_{m}^{χ} [ ℓ ] ( {β}_{m}^{χ} - {β}_{m}^{χ} [ ℓ ] ) ]$$
the convex upper bounds are introduced to the objective function as penalty functions to obtain a convex semidefinite programming (SDP) problem.

9. The semiFL method based on the NGMA technology according to claim 8, wherein solving the convex SDP problem comprises: continuously updating penalty factors η₁ and η₂ of the penalty terms, and solving the SDP problem through an iterative method until the penalty terms satisfy a predefined maximum violation or a predefined maximum quantity of outer iterations is reached.

10. The semiFL method based on the NGMA technology according to claim 6, wherein performing alternating optimization on the user power allocation subproblem and the STAR-RIS configuration subproblem comprises: initializing {pᵤ[0]}, {Qᵤ[0]}, {βᵤ[0]}, and preset accuracy ò₃; and setting a current iteration index [symbol] ₃=0, given {Qᵤ[ [symbol] ₃]} and {βᵤ[ [symbol] ₃]}, computing {pᵤ[ [symbol] ₃+1]} by using a closed-form expression of optimal user power allocation, given {pᵤ[ [symbol] ₃+1]}, updating {Qᵤ[ [symbol] ₃+1]} and {βᵤ[ [symbol] ₃+1]} through a penalty-based successive convex approximation (SCA) method, updating [symbol] ₃= [symbol] ₃+1, and repeating the foregoing process until a value of an objective function decreases to the preset accuracy or a preset maximum quantity L₃ of iterations is reached.
